(19) United States
(12) Patent Application Publication
(10) Pub. No.: US 2026/0351445 A1
(43) Pub. Date: Nov. 5, 2026

(54) CABLE

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: WEI XING, Huaian (CN); A-NAN YANG, Huaian (CN); HAN-RUN XIE, Huaian (CN); LU-YU CHANG, New Taipei (TW)

(21) Appl. No.: 19/659,280

(22) Filed: Apr. 27, 2026

(30) Foreign Application Priority Data
Apr. 30, 2025 (CN) 202520851514.1

(51) Int. Cl. H01B 11/10; H01B 1/02; H01B 3/00; H01B 3/42; H01B 7/02; H01B 11/00

(52) U.S. Cl. CPC H01B 11/10; H01B 1/02; H01B 3/004; H01B 3/421; H01B 7/0216; H01B 7/0275; H01B 11/002

(57) ABSTRACT

A cable includes: a pair of core wires; an insulating layer covering the pair of core wires; a shielding layer covering the insulating layer; and an outer insulating layer covering the shielding layer, wherein the shielding layer includes a middle layer, a copper layer on one side of the middle layer, and a metal aluminum layer on the other side of the middle layer.

### BACKGROUND OF THE INVENTION

### Field of the Invention

The present invention relates generally to a cable, and more particularly to a cable that has good electrical performance to transmit high-frequency signals.

### Description of Related Arts

With the development and popularization of electronic technology products, cables are widely used in household appliances, instrumentation, automation equipment, data centers, servers, switches, cloud computing and 5G as a tool for signal transmission. However, during signal transmission, cables are highly susceptible to interference from external electromagnetic signals. Therefore, shielding structures are often used to eliminate or reduce the interference from external electromagnetic fields and prevent signal leakage.

U.S. Pat. No. 11,798,710 discloses a cable comprising a pair of core wire, an insulating layer covering the pair of core wires, a shielding layer covering the insulating layer, and a sheath covering the shielding layer. The shielding layer is selected from the group consisting aluminum foil, copper foil, pure copper tape, silver-plated copper foil, bare copper wire, tin-plated copper, silver-plated copper, aluminum foil, copper foil, pure copper tape, and silver-plated copper foil.

It is desired to provide an improved cable with strong anti-interference performance and stable signal transmission.

### SUMMARY OF THE INVENTION

A main object of the present invention is to provide a cable with good shielding and stable signal transmission.

To achieve the above object, a cable includes: a pair of core wires; an insulating layer covering the pair of core wires; a shielding layer covering the insulating layer; and an outer insulating layer covering the shielding layer; wherein the shielding layer is a copper-aluminum composite layer. The copper-aluminum composite layer comprises a middle layer, a metal copper layer on one side of the middle layer, and a metal aluminum layer on the other side of the middle layer.

Compared to prior art, using the copper-aluminum composite layer as the shielding layer not only enhances the shielding effect of the cable, ensuring the reliability of signal transmission, but also improves bending resistance of the cable.

### BRIEF DESCRIPTION OF THE DRAWING

FIG. 1 is a cross-sectional view of a first embodiment of a cable of the present invention;

FIG. 2 is a cross-sectional view of a first embodiment of the shielding layer of the cable of the present invention;

FIG. 3 is a cross-sectional view of a second embodiment of the shielding layer of the cable of the present invention; and

FIG. 4 is a cross-sectional view of a second embodiment of a cable of the present invention.

### DETAILED DESCRIPTION OF THE PREFERRED EMBODIMENT

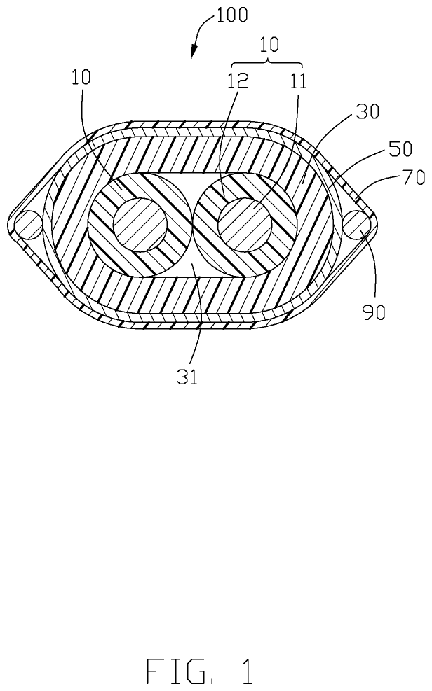

Referring to FIG. 1, a first embodiment of the cable 100 of the present invention is shown. The cable 100 comprises a pair of core wires 10, an insulating layer 30 covering the pair of core wires 10, a shielding layer 50 covering the insulating layer 30, an outer insulating layer 70 covering the outside of the shielding layer 50, and a ground wire 90 located between the shielding layer 50 and the outer insulating layer 70.

The pair of core wires 10 are in contact with each other and extend in a longitudinal direction. Each of the pair of core wires 10 comprises an inner conductor 11 and an inner insulating layer 12 extruded over the inner conductor 11. The inner conductor 11 is used for transmitting high-speed signals. The inner insulating layer 12 of each core wire 10 is extruded over the respective inner conductor 11. The inner conductor 11 is selected from the group consisting of silver-plated copper, alloy copper, and graphene copper. The material of the inner insulating layer 12 is PE (polyethylene) or foamed PE.

The insulating layer 30 is extruded over the pair of core wires 10. This structural configuration enables the cable 100 to maintain a small impedance variation even when the bending radius is relatively small; for example, when the bending radius equals the thickness of cable 100, the impedance change rate is less than 2 ohms. Air gaps 31 are formed on the upper and lower sides between the insulation layer 30 and the pair of core wires 10. The material of the insulating layer 30 is PE or foamed PE.

There are two ground wires 90. The two ground wires 90 are positioned on the left and right sides of the shielding layer 50, generally arranged along the extension line passing through the centers of the two inner conductors 11. The material of the ground wires 90 is tin-plated copper or silver-plated copper.

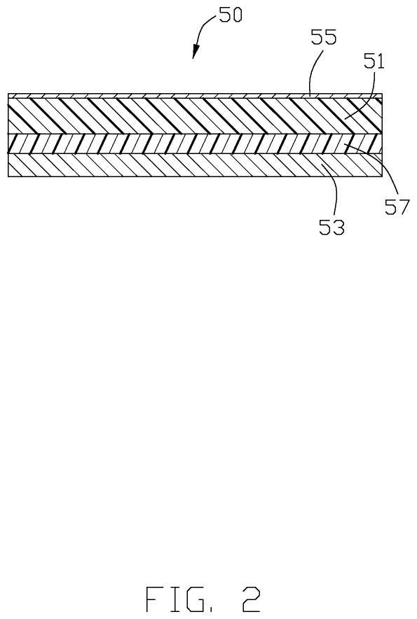

Referring to FIG. 2. The shielding layer 50 is a copper-aluminum composite layer. The shielding layer 50 includes a middle layer 51, a metal copper layer 53 on one side of the middle layer 51, and a metal aluminum layer 55 on the other side of the middle layer 51. The metal copper layer 53 is arranged on the inner side. The middle layer 51 is made of PET material. The metal copper layer 53 and the metal aluminum layer 55 are formed by different processes. The metal copper layer 53 is formed by a calendering process and is adhered to one side of the middle layer 51 with a TPU (Thermoplastic Polyurethane) composite adhesive layer 57. The metal aluminum layer 55 is electroplated onto the other side of the middle layer 51. The layers of the shielding layer 50 are arranged in the following order: metal aluminum layer 55, PET middle layer 51, TPU composite adhesive layer 57, and metal copper layer 53. In some embodiments, the thickness of the metal copper layer 53 is greater than the thickness of the metal aluminum layer 55. Specifically, the thickness of the metal copper layer 53 is 6 μm, the thickness of the metal aluminum layer 55 is 1 μm, and the thickness of the middle layer 51 is 12 μm. The shielding layer 50 is wrapped around the insulating layer 30 in a longitudinal wrapping manner or in a spiral winding manner. On one hand, copper has excellent conductivity and electrical properties. The metal copper layer 53, produced by rolling, has uniform density and provides excellent shielding performance, greatly improving the attenuation characteristics of cable 100. If the metal copper layer 53 is formed by electroplating, the thickness of the plating layer is limited due to process limitations, not exceeding 3 μm. Furthermore, the density of the electroplated layer is not optimal, affecting the shielding effect. On the other hand, copper is less ductile than aluminum and is prone to damage during bending. Aluminum has better ductility, making it easier to bend the cable 100. Furthermore, electroplating can make the aluminum layer 55 thinner. The combination of these two factors further enhances the shielding effect of the cable 100.

The outer insulating layer 70 is a PI (polyimide) tape. PI material can meet the VW-1 flame retardant rating requirement. In the present invention, the inner insulative layer 12, insulative layer 30, shielding layer 50, and outer insulating layer 70 of cable 100 are all made of PFAS (per-and polyfluoroalkyl substances) free materials, and can meet the environmental protection requirements of PFAS free.

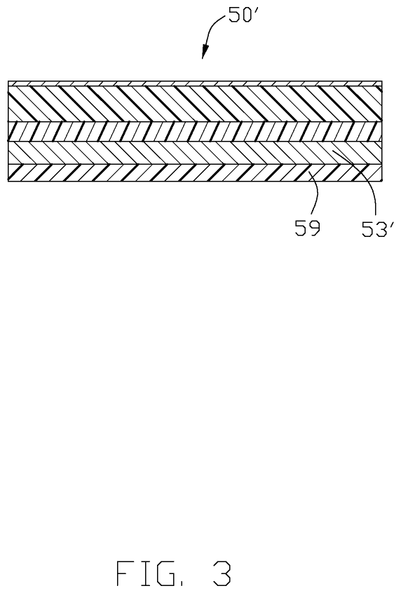

Referring to FIG. 3, another embodiment of the shielding layer 50′ of the cable 100 of present invention is shown. Compared with the shielding layer 50 in the first embodiment, the shielding layer 50′ in this embodiment further includes an EVA (ethylene vinyl acetate) hot melt adhesive layer 59 applied on the metal copper layer 53′. The shielding layer 50′ is fixed to the outside of the insulating layer 30 by EVA hot melt adhesive layer 59. The thickness of the TPU composite adhesive layer 57 is 6 μm.

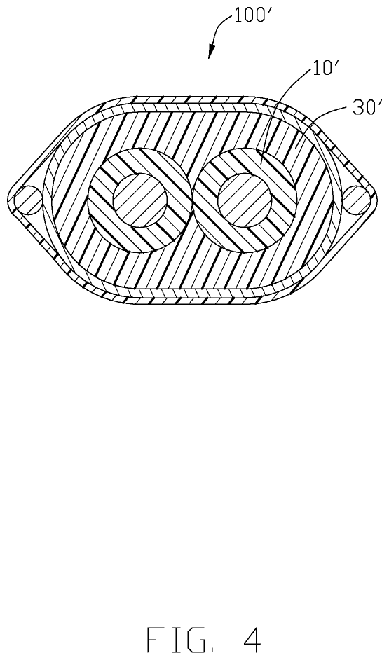

Referring to FIG. 4, a second embodiment of the cable 100 of present invention is shown. Compared with the cable 100 in the first embodiment, no air gaps 31 is provided in this embodiment. The insulating layer 30′ fills the space between the pair of core wires 10′ during extrusion.

The cable 100 of the present invention uses a copper-aluminum composite layer as the shielding layer 50, which not only increases the shielding effect of cable 100 but also improves its bending resistance. This provides more options for improving the high-frequency characteristics of cable 100, making it suitable for current rapid developing of high-speed cables.

1. A cable comprising:
a pair of core wires;
an insulating layer covering the pair of core wires;
a shielding layer covering the insulating layer; and
an outer insulating layer covering the shielding layer; wherein
the shielding layer comprises a middle layer, a copper layer on one side of the middle layer, and a metal aluminum layer on the other side of the middle layer.

2. The cable as claimed in claim 1, wherein the copper layer and the metal aluminum layer are formed through different processes.

3. The cable as claimed in claim 2, wherein the middle layer is made of PET material, the copper layer is made by a rolling process and bonded to one side of the middle layer with TPU composite adhesive, and the metal aluminum layer is electroplated on the other side of the middle layer.

4. The cable as claimed in claim 3, wherein the copper layer is arranged on an inner side of the middle layer.

5. The cable as claimed in claim 4, wherein the shielding layer comprises an EVA hot melt adhesive layer applied on the copper layer.

6. The cable as claimed in claim 1, wherein the thickness of the copper layer is greater than the thickness of the metal aluminum layer.

7. The cable as claimed in claim 6, wherein the thickness of the copper layer is 6 μm, the thickness of the metal aluminum layer is 1 μm, the thickness of the middle layer is 12 μm, and the thickness of the TPU composite adhesive is 6 μm.

8. The cable as claimed in claim 1, wherein each of the pair of core wires includes an inner conductor and an inner insulative layer extruded over the inner conductor, the insulating layer is extruded over the pair of core wires.

9. The cable as claimed in claim 8, wherein the inner conductor is selected from the group consisting of silver-plated copper, alloy copper, and graphene copper. The material of the inner insulating layer is PE or foamed PE, and the material of the insulating layer is PE or foamed PE.

10. The cable as claimed in claim 1, further comprising at least one ground wire disposed between the shielding layer and the outer insulating layer, and the material of the ground wire is tin-plated copper or silver-plated copper.

11. The cable as claimed in claim 1, wherein the outer insulating layer is a PI tape.
